(19) United States
(12) Patent Application Publication
(10) Pub. No.: US 2026/0109848 A1
(43) Pub. Date: Apr. 23, 2026

(54) CRACK-RESISTANT TWO-COMPONENT EPOXY RESIN COMPOSITION

(71) Applicant: SIKA TECHNOLOGY AG, Baar (CH)

(72) Inventors: Amelie HURET, Massy (FR); Gilles LAMBRINOS, Saint Ouen I'Aumône (FR); Fleur LESETRE, Arras (FR)

(73) Assignee: SIKA TECHNOLOGY AG, Baar (CH)

(21) Appl. No.: 18/703,875

(22) PCT Filed: Oct. 25, 2022
(86) PCT No.: PCT/EP2022/079798

§ 371 Date: Apr. 23, 2024

(30) Foreign Application Priority Data
Oct. 25, 2021 (EP) 21204485.3

(51) Int. Cl. C08L 63/00; C08G 18/10; C08G 18/67

(52) U.S. Cl. CPC C08L 63/00; C08G 18/10; C08G 18/6715; C08L 2203/20

(57) ABSTRACT

A two-component epoxy resin composition, consisting of a first component K1 including at least one epoxy resin A that contains on average more than one epoxy group per molecule; and a second component K2 including at least one anhydride-functional hardener B for epoxy resins and preferably a curing accelerator for anhydride-cured epoxy resins; characterized in that component K1 contains between 2 and 35 wt.-%, preferably between 3 and 25 wt.-%, in particular between 5 and 15 wt.-%, based on the total weight of component K1, of at least one toughener T, wherein said toughener T is a reaction product of at least one polymeric diol, at least one polyisocyanate, and cardanol. The two-component epoxy resin composition exhibits excellent thermally induced crack resistance and is highly suitable as electrical insulation for electric or electronic equipment or as casting resin in industrial assembly.

### TECHNICAL FIELD

The present invention relates to the field of two-component epoxy resin compositions that cure with anhydride hardeners, in particular suitable for electrical insulation of equipment such as transformers and switchgears and epoxy castings for metal housings, for example in automotive assembly.

### PRIOR ART

Epoxy-based compositions play an important role in industrial bonding, for example assembly of structural elements, or composite bonding or as casting and insulating materials in electronics manufacturing. Epoxy-based compositions are generally inexpensive, possess very favorable adhesion properties on many substrates such as metal and fibrous materials and exhibit high cohesive and adhesive strengths, as well as highly suitable electrical insulation properties for electric and electronic applications. Such epoxy-based compositions are often formulated in a two-component manner, whereby in a first component the epoxy resin is contained, and in a second component the hardeners for said epoxy resin, for example amines or anhydrides, are contained. By separating these reactive species in separate packages, highly storage-stable compositions are obtained that cure rapidly under elevated temperatures when the two components are mixed together before application of the epoxy-based composition. This two-component approach furthermore allows for highly reactive, fast curing systems that are curable at room temperature or under elevated temperature conditions and that could not be formulated with these properties in a one-component approach due to storage stability limitations. Especially in industrial applications, a fast curing rate and fast strength build-up is often a prerequisite for any given application.

Epoxy resins can be cured with a range of different hardeners, such as amines or anhydrides. Compared to the usually more common amine-cured epoxy resin compositions, anhydride-cured epoxy resins systems have many interesting advantageous properties. For example, they exhibit a lower mix viscosity, they cure at elevated temperature, which is beneficial in terms of process control and storage stability, their curing reaction is less exotherm, they exhibit low cure shrinkage, have generally better electrical insulation properties, higher glass transition temperature (Tg), a longer pot life, and better thermal stability than similar amine-cured epoxy resin compositions. Furthermore, anhydride-cured epoxy resins can be much easier degassed than amine-cured epoxy resins, which is highly advantageous for potting resin applications where remaining enclosed gas bubbles are highly undesired.

However, while anhydride-cured epoxy systems offer many benefits in comparison with amine-cured systems, there are some notable drawbacks that limit their utilization. For example, there is the intrinsic drawback of the fast reaction between anhydrides and water and generally a higher moisture sensitivity. More importantly, anhydride-cured epoxy resins compositions generally exhibit a low resistance to crack initiation and propagation under thermal shocks (fast and high temperature gradients).

In general, epoxy-anhydride systems are preferably used in certain industrial applications because of their excellent mechanical and thermal properties such as high modulus and high glass transition temperature. However, their low resistance to crack initiation and propagation under thermal shocks is a significant problem especially where the cured epoxy resin composition is exposed to thermal or mechanical stress.

Several methods to improve crack resistance and resistance to thermal shocks have been developed, which improve the toughness of the epoxy resins and the resistance to thermally induced cracking.

Typically, additives such as toughener agents and specific fillers are added to the compositions in order to improve crack resistance, such as for example wollastonite fillers.

Another common measure to improve toughness and crack resistance is to include flexibilizers and plasticizers in epoxy resin compositions. These additives generally improve the flexibility of the compositions and as a result the toughness and somewhat the crack resistance. In the meantime however, this flexibilization is accompanied by detrimental reduction of Tg, elastic modulus and hardness properties.

Liquid rubbers, for example, have a relatively long history of use as tougheners. Examples of liquid rubbers used are those based on acrylonitrile/butadiene copolymers, examples being obtainable under the trade name Hycar®.

Among the most often used tougheners in epoxy compositions are furthermore so-called core-shell rubbers, which not only improve impact force resistance of epoxy resins, but also thermally induced crack resistance in epoxy-anhydride compositions.

A comparably novel class of tougheners are polyurethane-based tougheners. For example, WO A 2004/055092 and WO A 2005/007720 disclose epoxy resin compositions with improved impact resistance, which comprise a reaction product of a polyurethane prepolymer terminated by isocyanate groups with a low-molecular weight monohydroxyepoxide. These epoxy resin compositions have improved low-temperature impact resistance when compared with those comprising phenol-terminated polyurethane prepolymers, but these polyurethane-based tougheners when used in epoxy-anhydride systems cannot impart a sufficiently high thermally induced crack resistance. There is therefore a need for an easily prepared toughener additive that leads to significantly improved thermally induced crack resistance in epoxy-anhydride compositions. Additionally, it is desirable that this additive does not decrease the glass transition temperature of the cured epoxy composition to below 100° C.

### DISCLOSURE OF THE INVENTION

Accordingly, it is the object of the present invention to provide a two-component epoxy resin composition that cures with anhydrides at temperatures of at least 100° C. and exhibits excellent thermally induced crack resistance, while having a glass transition temperature of at least 100° C.

Surprisingly, it was found that by using very specific tougheners based on polymeric diols, polyisocyanates, and cardanol, highly thermally induced crack resistant two-component epoxy-anhydride compositions can be obtained, that are suitable for electrical insulation of equipment such as transformers and switchgears and epoxy castings for metal housings, for example in automotive assembly.

The invention relates in a first aspect to a two-component epoxy resin composition, consisting of
a first component K1 comprising at least one epoxy resin A that contains on average more than one epoxy group per molecule; and
a second component K2 comprising at least one anhydride-functional hardener B for epoxy resins and preferably a curing accelerator for anhydride-cured epoxy resins;
characterized in that component K1 contains between 2 and 35 wt.-%, preferably between 3 and 25 wt.-%, in particular between 5 and 15 wt.-%, based on the total weight of component K1, of at least one toughener T, wherein said toughener T is a reaction product of at least one polymeric diol, at least one polyisocyanate, and cardanol.

Other aspects of the present invention are the subject matter of additional independent claims. Especially preferred embodiments are the subject matter of the dependent claims.

### WAYS OF CARRYING OUT THE INVENTION

The term “polymer” as used in the present document, on the one hand, refers to a collective of chemically uniform macromolecules prepared by a polyreaction (polymerization, polyaddition, polycondensation) where, however, the macromolecules differ with respect to their degree of polymerization, molecular weight and chain length. On the other hand, the term also comprises derivatives of said collective of macromolecules resulting from polyreactions, that is, compounds which were obtained by reactions such as, e.g., additions or substitutions, of functional groups in predetermined macromolecules and which may be chemically uniform or chemically non-uniform. Moreover, the term also comprises so-called prepolymers, that is, reactive organic pre-adducts, the functional groups of which participate in the formation of macromolecules.

The term “polymeric diol” in the context of this document describes a polymer having, at least on average, two hydroxyl groups, typically at the polymer chain ends.

The prefix “poly” in substance names such as “polyol”, “polyiso-cyanate”, “polyether” or “polyamine” in the present document means that the respective substance formally contains more than one of the functional group present in its name per molecule.

The term “anhydride-functional hardener” means an organic molecule having at least one, preferably more, carboxylic anhydride groups that is reactive with epoxy groups under suitable reaction conditions, as for example a suitable temperature, and is thus able to act as curing agent for an epoxy resin. “Molecular weight” or, synonymously, “molar mass” is defined in the present document as the molar mass (in grams per mole) of a molecule. The “average molecular weight” or “average molar mass” is the term used for the average molar mass Mₙ of an oligomeric or polymeric mixture of molecules exhibiting a certain polydispersity, which is usually determined by gel permeation chromatography (GPC) against polystyrene as standard.

“Primary hydroxyl group” is the term applied to an OH group bonded to a C-Atom with at least two hydrogens.

“Open time” is the term used in this document for the time within which the parts to be bonded must be fitted together after the components are mixed. “Room temperature” in the present document means a temperature of 23° C.

In this document, the use of the term “independently of one another” in connection with substituents, moieties or groups should be interpreted such that substituents, moieties or groups with the same designation may be present simultaneously in the same molecule with different definitions.

The term “room temperature” (“RT”) refers to a temperature of 23° C., if not otherwise specified.

All industrial standards and norms cited refer to the most recent versions at the time of first filing of this patent application, if not otherwise specified.

The terms “weight” refers in this document to the mass of a compound or composition as measured in kilograms.

The two-component epoxy resin composition consists of two components. The first component K1, the resin component, contains all epoxy-functional compounds.

The second component K2, the hardener component, contains chemical species that are able to react with epoxies under formation of a cross-linked or chemically cured product. These hardener compounds are anhydride-functional hardeners.

Components K1 and K2 are mixed together before or during application, which accompanied by heating starts the cross-linking or curing reactions and ultimately yields a cured, hardened product.

The two-component epoxy resin composition contains a first component K1 comprising least one epoxy resin A that contains on average more than one epoxy group per molecule. Preferably, component K1 of the two-component epoxy resin composition contains said epoxy resin A with an amount of between 10 and 85 wt.-%, preferably between 25 and 50 wt.-%, based on the total weight of component K1.

The epoxy resin A contained in the first component K1 of the two-component composition may be any conventional di- or multifunctional epoxy resin used in this field. Suitable epoxy resins are available e.g. from the reaction of an epoxide compound such as e.g. epichlorohydrin with a polyfunctional aliphatic or aromatic alcohol, i.e. a diol, triol or polyol. One or more epoxy resins may be used.

The epoxy resin A that contains on average more than one epoxy group per molecule is preferably a liquid epoxy resin and/or a solid epoxy resin.

The term “solid epoxy resin” is very well known to a person skilled in the art of epoxides and is used in contrast to “liquid epoxy resins”. The glass transition temperature of solid resins is above room temperature, i.e. they can be comminuted to free-flowing powders at room temperature.

Suitable as an epoxy liquid resin or solid epoxy resin is in particular a diglycidyl ether, e.g. of the formula (I)

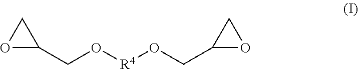

wherein R⁴ is a divalent aliphatic or mononuclear aromatic or a dinuclear aromatic residue.

Examples of such diglycidyl ethers are in particular diglycidyl ethers of difunctional saturated or unsaturated, branched or unbranched, cyclic or open-chain C₂-C₃₀ alcohols, such as e.g. ethylene glycol, butanediol, hexanediol, or octanediol glycidyl ether, cyclohexane dimethanol diglycidyl ether, neopentyl glycol diglycidyl ether;

Diglycidyl ethers of difunctional, low to high molecular weight polyether polyols, e.g. polyethylene glycol diglycidyl ether, polypropyleneglycol diglycidyl ether; Diglycidyl ethers of difunctional diphenols and optionally triphenols, which are understood not only pure phenols, but optionally also substituted phenols. The type of substitution can be very diverse. In particular, this is understood to mean a substitution directly on the aromatic nucleus to which the phenolic OH group is bonded. In addition, phenols are understood to mean not only mononuclear aromatics but also polynuclear or condensed aromatics or heteroaromatics which have the phenolic OH group directly on the aromatic or heteroaromatic compounds. As bisphenols and, optionally, triphenols, 1,4-dihydroxybenzene, 1,3-dihydroxybenzene, 1,2-dihydroxybenzene, 1,3-dihydroxytoluene, 3,5-dihydroxybenzoate, 2,2-bis(4-hydroxyphenyl) are, for example, suitable. propane (=bisphenol-A), bis(4-hydroxyphenyl) methane (=bisphenol-F), bis(4-hydroxyphenyl) sulfone (=bisphenol-S), naphthoresorcinol, dihydroxynaphthalene, dihydroxyanthraquinone, dihydroxy-biphenyl, 3,3-Bis (p-hydroxyphenyl) phthalide, 5,5-bis(4-hydroxy-phenyl) hexahydro-4,7-methanoindane, phenolphthalein, fluorescein, 4,4′-[bis(hydroxyphenyl)-1,3-phenylenebis(1-methyl-ethylidene)] (=bisphenol-M), 4,4′-[bis(hydroxyphenyl)-1,4-phenylenebis(1-methyl-ethylidene)] (=bisphenol-P), 2,2′-diallyl-bisphenol-A, diphenols and dicresols prepared by reacting phenols or cresols with diisopropylidenbenzene, phloroglucin, bile acid esters, phenol or cresol novolaks with —OH functionality of 2.0 to 3.5 and all isomers the aforementioned compounds.

Preferred solid epoxy resins A have the formula (II)

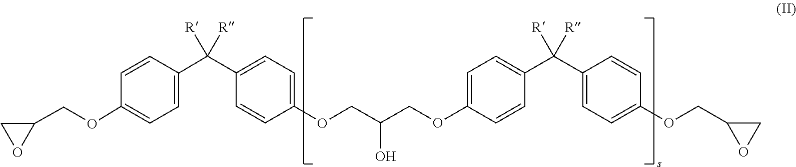

In this formula, the substituents R′ and R″ are each independently H or CH₃. In addition, the index s has a value of >1.5, in particular of 2 to 12.

Such solid epoxy resins are commercially available, for example from Dow, Huntsman or Hexion.

Compounds of the formula (II) with an index s between 1 and 1.5 are referred to by a person skilled in the art as semisolid epoxy resins. For this present invention, they are likewise considered to be solid resins. However, preferred are epoxy resins in the narrower sense, i.e. the index s has a value of >1.5.

Preferred liquid epoxy resins A have the formula (III)

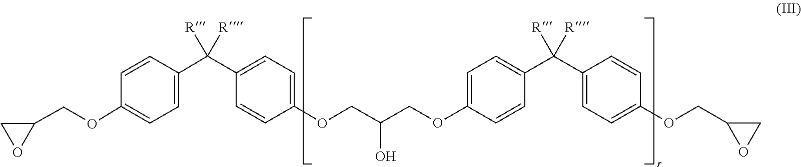

In this formula, the substituents R′″ and R″″ are each independently H or CH₃. In addition, the index r has a value of 0 to 1. Preferably, r has a value of less than 0.2.

These are thus preferably diglycidyl ethers of bisphenol A (DGEBA), of bisphenol F and of bisphenol A/F (here, the designation “A/F” refers to a mixture of acetone with formaldehyde which is used as the reactant in the preparation thereof). Such liquid resins are available, for example, as Araldite® GY 250, Araldite® PY 304, Araldite® GY 282 (Huntsman), or D.E.R.™ 331, or D.E.R.™ 330 (Olin), or Epikote 828 (Hexion).

Moreover, so-called novolacs are suitable epoxy resins A. These have in particular the following formula:

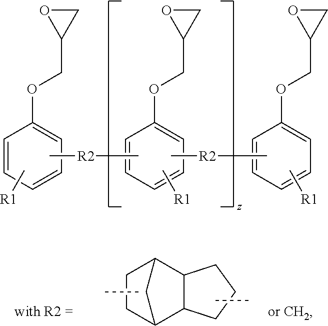

R1=H or methyl and z=0 to 7.

In particular, they are phenol or cresol novolacs (R2═CH₂).

Such epoxy resins are commercially available under the trade names

EPN or ECN as well as Tactix® 556 from Huntsman or under the product line D.E.N.™ from Dow Chemical.

Preferably, the epoxy resin A is a liquid epoxy resin of the formula (III). In an even more preferred embodiment, the heat-curing epoxy resin composition contains at least one liquid epoxy resin of formula (III) as well as at least one solid epoxy resin of formula (II).

In preferred embodiments of the two-component epoxy resin composition according to the invention, said at least one epoxy resin A, which may be a mixture of different liquid and optionally solid epoxy resins, is liquid at 25° C., preferably having a viscosity determined according to ASTM D-445 of below 15 Pa's, and has an epoxy equivalent weight determined according to ASTM D-1652 of between 160 and 200 g/eq.

Particular preference is given to bisphenol A diglycidyl ether, bisphenol F diglycidyl ether or bisphenol A/F diglycidyl ether, in particular Araldite® GY 240, Aralite® GY 250, Araldite® GY 281, Araldite® GY 282, Araldite® GY 285, Araldite® PY 304 or Araldite® PY 720 (all from Huntsman), or D.E.R.® 330, D.E.R.® 331, D.E.R.® 332, D.E.R.® 336, D.E.R.® 351, D.E.R.® 352, D.E.R.® 354 or D.E.R.® 356 (all from Olin), or novolak glycidyl ether.

Preferred is a novolak glycidyl ether that is derived from phenol-formaldehyde novolaks, which are also referred to as epoxy phenol novolac resins.

Such novolac glycidyl ethers are commercially available, for example from Olin, Huntsman, Momentive or Emerald Performance Materials. Preferred types are D.E.N.® 431, D.E.N. 438 or D.E.N.® 439 (from Olin), Araldite® EPN 1179, Araldite® EPN 1180, Araldite® EPN 1182 or Araldite® EPN 1183 (from Huntsman), Epon® 154, Epon® 160 or Epon® 161 (from Momentive) or Epalloy® 8250, Epalloy® 8330 or Epalloy® 8350 (from Emerald Performance Materials).

Additionally, mono-, di- and multifunctional reactive diluents (e.g. butandiol diglycidylether) may be comprised in component K1 of the composition.

These reactive diluents are in particular:
glycidyl ethers of monofunctional saturated or unsaturated, branched or unbranched, cyclic or open-chain C₄-C₃₀ alcohols, in particular selected from the group consisting of butanol glycidyl ether, hexanol glycidyl ether, 2-ethylhexanol glycidyl ether, allyl glycidyl ether, tetrahydrofurfuryl and furfuryl glycidyl ether, trimethoxysilyl glycidyl ether.
glycidyl ethers of difunctional saturated or unsaturated, branched or unbranched, cyclic or open-chain C₂-C₃₀ alcohols, in particular selected from the group consisting of ethylene glycol, butanediol, hexanediol, or octanediol glycidyl ethers, cyclohexane dimethanol diglycidyl ether and neopentyl glycol diglycidyl ether,
glycidyl ethers of tri- or polyfunctional, saturated or unsaturated, branched or unbranched, cyclic or open-chain alcohols, such as epoxidized castor oil, epoxidized trimethylolpropane, epoxidized pentaerythritol or polyglycidyl ethers of aliphatic polyols such as sorbitol, glycerol or trimethylol propane.
glycidyl ethers of phenol and aniline compounds, in particular selected from the group consisting of phenyl glycidyl ether, cresyl glycidyl ether, p-tert-butyl-phenyl glycidyl ether, nonylphenol glycidyl ether, 3-n-pentadecenyl glycidyl ether (from cashew nut shell oil), N, N-diglycidyl aniline and triglycidyl of p-aminophenol.
epoxidized amines such as N,N-diglycidyl cyclohexylamine.
epoxidized mono- or dicarboxylic acids, in particular selected from the group consisting of glycidyl neodecanoate, glycidyl methacrylate, glycidyl benzoate, diglycidyl phthalate, tetra- and hexahydrophthalate and diglycidyl esters of dimeric fatty acids and diglycidyl esters of terephthalic acid and trimellitic acid.
epoxidized di- or trifunctional, low to high molecular weight polyether polyols, in particular polyethylene glycol diglycidyl ether or polypropylene glycol diglycidyl ether.

Particularly preferred are hexanediol diglycidyl ether, cresyl glycidyl ether, p-tert-butylphenyl glycidyl ether, polypropylene glycol diglycidyl ether and polyethylene glycol diglycidyl ether.

Advantageously, the total proportion of the reactive diluent is from 0.1 to 20% by weight, preferably from 1 to 8% by weight, based on the weight of the total two-component composition.

Furthermore, component K1 contains between 2 and 35 wt.-%, preferably between 3 and 25 wt.-%, in particular between 5 and 15 wt.-%, based on the total weight of component K1, of at least one toughener T, wherein said toughener T is a reaction product of at least one polymeric diol, at least one polyisocyanate, and cardanol.

This amount refers to the pure active toughener without solvents or other solid or liquid optional additives commonly used in polymer chemistry for better storage, handling, dispersion, dilution, or other purposes.

Toughener T is a reaction product of at least one polymeric diol, at least one polyisocyanate, and cardanol.

In this reaction, the polymeric diol is preferably reacted in a first step with the polyisocyanate in order to yield an isocyanate-functional polyurethane prepolymer. The isocyanate groups of said polyurethane prepolymer are then preferably endcapped with cardanol in order to yield the final toughener T. Said toughener T preferably contains no more isocyanate groups in measurable amounts. In particular, it is preferred that at least 75%, in particular at least 90%, preferably at least 99% of all remaining isocyanate groups of said prepolymer are endcapped with cardanol after synthesis of toughener T.

It is possible to produce a prepolymer with significant amounts of chain extension when the polymeric diol and the polyisocyanate are reacted. It is also possible to produce a prepolymer with essentially no chain extension when the polymeric diol and the polyisocyanate are reacted. The skilled person in the field of polyurethane chemistry is able to control the amount of chain extension, e.g. by adjusting the relative molar ratio of polymeric diol to polyisocyanate. With a significant molar excess of polyisocyanate, the chain extension reactions will be suppressed, yielding isocyanate-functional prepolymers with mainly no chain-extended polymer chains. When the molar ratio of polymeric diol and polyisocyanate, in particular diisocyanate, approaches 1:1, significant chain extension is to be expected. In general, a molar excess of polyisocyanate is preferred. However, when a large excess of polyisocyanate is used, non-reacted polyisocyanate may have to be removed after reaction, e.g. by distillation or chemical derivatization.

The isocyanate group-containing prepolymer for toughener T is obtained, in particular, from the reaction of at least one monomeric polyisocyanate, in particular diisocyanate, and at least one suitable diol. The reaction is preferably carried out with exclusion of moisture at a temperature in the range from 20 to 160° C., in particular from 40 to 140° C., if appropriate in the presence of suitable catalysts.

The NCO/OH ratio employed in the synthesis reaction is preferably in the range of 1.1/1 to 10/1, preferably 1.3/1 to 10/1. The monomeric polyisocyanate remaining in the reaction mixture after the reaction of the OH groups can be removed, in particular by means of distillation.

In the event that excess monomeric polyisocyanate is removed by distillation, the NCO/OH ratio in the reaction is preferably in the range from 3/1 to 10/1, in particular 4/1 to 7/1, and the resulting isocyanate group-containing prepolymer after the distillation preferably contains at most 0.5% by weight, particularly preferably at most 0.3% by weight, of monomeric polyisocyanate. A toughener T synthesized with this approach not only has the EHS and regulatory advantage of possessing a lower monomeric diisocyanate content, but also generally exhibits a lower polydispersity, lower viscosity, and often better mechanical performance compared to a toughener T synthesized according to the following parameters.

In the event that no excess monomeric polyisocyanate is removed from the prepolymer, the NCO/OH ratio in the reaction is preferably in the range from 1.3/1 to 2.5/1. Such a prepolymer contains in particular at most 3% by weight, preferably at most 2% by weight, of monomeric polyisocyanate.

Preferred tougheners T are a polymer of the formula (IV).

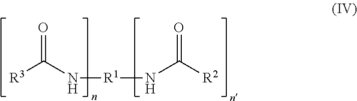

In this formula, n and n′ independently of one another are each either 0 or 1, preferably both 1, with the provisio that at least one, preferably both of n and n′ are not 0;

R¹ is a linear polyurethane prepolymer containing at least n+n′ terminal isocyanate groups, after removal of n+n′ terminal isocyanate groups; R² and R³ are residues of cardanol after removal of the hydroxyl H atom and are bonded via the oxygen atom.

Cardanol (CAS registry number: 37330-39-5) is a phenolic lipid obtained from anacardic acid, the main component of cashew nutshell liquid (CNSL), a byproduct of cashew nut processing. The name of the substance is derived by contraction from the genus Anacardium, which includes the cashew tree, Anacardium occidentale. The structure is shown in formula (V).

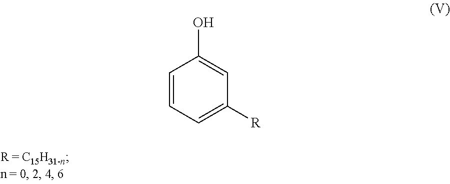

The name cardanol is used for the decarboxylated derivatives obtained by thermal decomposition of any of the naturally occurring anacardic acids. This includes more than one compound because the composition of the side chain varies in its degree of unsaturation. Tri-unsaturated cardanol, the major component (41%) is shown below in formula (VI). The remaining cardanol is 34% mono-unsaturated, 22% bi-unsaturated, and 2% saturated.

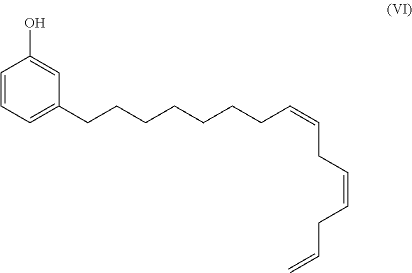 [SMILES: C=CC/C=C\C/C=C\CCCCCCCc1cccc(O)c1]

The phenolic OH group of cardanol readily reacts with the isocyanate groups of the isocyanate-functional prepolymer to yield toughener T.

It is noteworthy and surprising that cardanol is the only phenolic reagent that can be used in production of the toughener T of the present invention. Other, similar phenolic reagents, in particular nonylphenol, do not lead to an additive with the same extent of beneficial properties as toughener T.

Furthermore, cardanol has the advantage of being based on natural, renewable resources and it is inexpensive.

Cardanol is commercially available, for example under the trade name Cardolite® NC-700 by Cardolite Corporation.

In the process for preparing prepolymer that is endcapped by cardanol to produce toughener T, at least one polymeric diol is used. Suitable polymeric diols are especially the following commercial diols or any desired mixtures thereof:
polyoxyalkylene diols, also called polyether diols or oligoetherols, which are polymerization products of ethylene oxide, 1,2-propylene oxide, 1,2- or 2,3-butylene oxide, oxetane, tetrahydrofuran or mixtures thereof, possibly polymerized with the aid of a starter molecule having two active hydrogen atoms, for example water or compounds having a plurality of OH or NH groups, for example ethane-1,2-diol, propane-1,2- and 1,3-diol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, cyclohexane-1,3- and -1,4-dimethanol, bisphenol A, hydrogenated bisphenol A, aniline, and mixtures of the aforementioned compounds. Preference is given to polyoxyalkylene diols having a low degree of unsaturation (measured to ASTM D-2849-69 and reported in milliequivalents of unsaturation per gram of polyol (meq/g)), prepared, for example, with the aid of double metal cyanide complex catalysts (DMC catalysts).
Particularly suitable are polyoxyalkylenediols, especially polyoxyethylene- and polyoxypropylenediols.
Additionally particularly suitable are what are called ethylene oxide-terminated (EO-endcapped) polyoxypropylenediols. The latter are polyoxyethylene-polyoxypropylene copolymers which are obtained, for example, by further alkoxylating polyoxypropylene diols with ethylene oxide on completion of the polypropoxylation reaction and thus have primary hydroxyl groups.
Styrene-acrylonitrile- or acrylonitrile-methyl methacrylate-grafted polyether diols.
Polyester diols, also called oligoesterols, prepared by known processes, especially the polycondensation of hydroxycarboxylic acids or the polycondensation of aliphatic and/or aromatic polycarboxylic acids with dihydric alcohols.
Especially suitable polyester diols are those prepared from dihydric alcohols, for example ethylene glycol, diethylene glycol, propylene glycol, dipropylene glycol, neopentyl glycol, butane-1,4-diol, pentane-1,5-diol, 3-methylhexane-1,5-diol, hexane-1,6-diol, octane-1,8-diol, decane-1,10-diol, dodecane-1,12-diol, 1,12-hydroxystearyl alcohol, cyclohexane-1,4-dimethanol, dimer fatty acid diol (dimer diol), neopentyl glycol hydroxypivalate, or mixtures of the aforementioned alcohols, with organic dicarboxylic acids, or the anhydrides or esters thereof, for example succinic acid, glutaric acid, adipic acid, trimethyladipic acid, suberic acid, azelaic acid, sebacic acid, dodecanedicarboxylic acid, maleic acid, fumaric acid, dimer fatty acid, phthalic acid, phthalic anhydride, isophthalic acid, terephthalic acid, dimethyl terephthalate, hexahydrophthalic acid, or mixtures of the aforementioned acids, and also polyester diols formed from lactones, for example from γ-caprolactone, and starters such as the aforementioned dihydric alcohols.
Polycarbonate diols as obtainable by reaction, for example, of the abovementioned alcohols—used to form the polyester diols—with dialkyl carbonates, diaryl carbonates or phosgene.
Block copolymers bearing two hydroxyl groups and having at least two different blocks having polyether, polyester and/or polycarbonate structure of the type described above, especially polyether polyester diols.
Polyacrylate- and polymethacrylatediols.
Dihydroxy-functional fats and oils, for example natural fats and oils, especially castor oil; or what are called oleochemical diols, obtained by chemical modification of natural fats and oils, for example the epoxy polyesters or epoxy polyethers obtained by epoxidation of unsaturated oils and subsequent ring opening with carboxylic acids or alcohols, or diols obtained by hydroformylation and hydrogenation of unsaturated oils; or diols obtained from natural fats and oils by degradation processes such as alcoholysis or ozonolysis and subsequent chemical linkage, for example by transesterification or dimerization, of the degradation products or derivatives thereof thus obtained. Suitable degradation products of natural fats and oils are especially fatty acids and fatty alcohols, and also fatty acid esters, especially the methyl esters (FAME), which can be derivatized, for example, by hydroformylation and hydrogenation to give hydroxy fatty acid esters.
Polyhydrocarbondiols, also called oligohydrocarbonols, for example dihydroxy-functional polyolefins, polyisobutylenes, polyisoprenes; dihydroxy-functional ethylene-propylene, ethylene-butylene or ethylene-propylene-diene copolymers, as produced, for example, by Kraton Polymers; dihydroxy-functional polymers of dienes, especially of 1,3-butadiene, which may also be prepared from anionic polymerization in particular; dihydroxy-functional copolymers of dienes such as 1,3-butadiene or diene mixtures and vinyl monomers such as styrene, acrylonitrile, vinyl chloride, vinyl acetate, vinyl alcohol, isobutylene and isoprene, for example dihydroxy-functional acrylonitrile/butadiene copolymers, as producible, for example, from epoxides or amino alcohols and carboxyl-terminated acrylonitrile/butadiene copolymers (commercially available, for example, under the Hypro® (formerly Hycar®) CTBN and CTBNX and ETBN name from Nanoresins AG, Germany, or Emerald Performance Materials LLC); and hydrogenated dihydroxy-functional polymers or copolymers of dienes.

Particular preference is given to such diols with an average OH functionality in the range of 1.5 to 2.5, preferably 1.8 to 2.3.

Preferred diols are polyoxyalkylene diols, polyester diols, polycarbonate diols, polybutadiene diols, and poly(meth)acrylate diols. Among those, particularly preferred are polyether diols, in particular polypropylene glycol diols and polytetrahydrofuran diols.

Particular preference is given firstly to, in particular room temperature liquid, polyoxypropylenediols and polyoxyethylene-polyoxypropylene codiols, especially polyoxypropylenediols having a mean molecular weight in the range from 300 to 15′000 g/mol, in particular 1′000 to 10′000 g/mol, preferably from 2′000 to 5′500 g/mol. Particular preference is given to such diols with an average OH functionality in the range of 1.5 to 2.5, preferably 1.8 to 2.3.

Particular preference is further given to room temperature liquid or solid, amorphous or semicrystalline or crystalline diols, especially polyesterpolyols and polycarbonate diols, especially polyesterdiols having a mean molecular weight in the range from 300 to 15′000 g/mol, in particular 1′000 to 10′000 g/mol, preferably 1′500 to 8000 g/mol, especially 2′000 to 5′500 g/mol. Particularly suitable are crystalline or semicrystalline adipic acid/hexanediol polyesters and dodecanedicarboxylic acid/hexanediol polyesters.

Particular preference is further given to polybutadiene diols with an average OH functionality in the range of 1.5 to 2.5, preferably 1.8 to 2.3, and an average molar mass in the range of 300 to 15′000 g/mol, in particular 1′000 to 10′000 g/mol, preferably 1′500 to 8000 g/mol, more preferably 2000 to 4000 g/mol, especially 2500 to 3000 g/mol.

Such polybutadiene polyols are especially obtainable by the polymerization of 1,3-butadiene and allyl alcohol in a suitable proportion or by the oxidation of suitable polybutadienes.

Suitable polybutadiene polyols are especially polybutadiene diols containing structural elements of formula (VII) and optionally structural elements of formulas (VIII) and (IX).

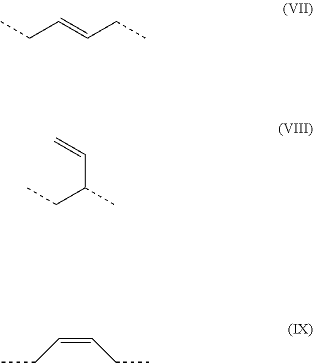

Preferred polybutadiene diols contain
40 to 80%, especially 55 to 65% of the structural element of formula (VII),
0 to 30%, especially 15 to 25%, of the structural element of formula (VIII),
0 to 30%, especially 15 to 25%, of the structural element of formula (IX).

Particularly suitable polybutadiene polyols are, for example, available form Cray Valley under the trade name range Poly bd®.

Most preferred of all diols for the synthesis of toughener T are, in particular liquid at room temperature, polyoxypropylenediols and polyoxyethylene-polyoxypropylene codiols, especially polyoxypropylenediols having a mean molecular weight in the range from 300 to 15′000 g/mol, in particular 1′000 to 10′000 g/mol, preferably from 2′000 to 5′500 g/mol. With these diols, especially high impact peel strengths can be obtained. Thus, in the most preferred embodiments, said diol is a polyoxypropylenediol r ao polyoxyethylene-polyoxypropylene copolymer diol, especially a polyoxypropylenediol having a mean molecular weight in the range from 300 to 15′000 g/mol, in particular 1′000 to 10′000 g/mol, preferably from 2′000 to 5′500 g/mol. Particular preference is given to such diols with an average OH functionality in the range of 1.5 to 2.5, preferably 1.8 to 2.3.

In the process for preparing prepolymer that is endcapped by cardanol to produce toughener T, at least one polyisocyanate, preferably diisocyanate is used.

Suitable polyisocyanates are especially monomeric di- or triisocyanates, as well as oligomers, polymers and derivatives of the monomeric di- or triisocyanates, as well as arbitrary mixtures thereof.

Suitable aromatic monomeric di- or triisocyanates are especially 2,4- and 2,6-toluene diisocyanate and arbitrary mixtures of these isomers (TDI), 4,4′-, 2,4′- and 2,2′-diphenylmethane diisocyanate and arbitrary mixtures of these isomers (MDI), mixtures of MDI and MDI homologs (polymeric MDI or PMDI), 1,3- and 1,4-phenylene diisocyanate, 2,3,5,6-tetramethyl-1,4-diisocyanatobenzene, naphthalene-1,5-diisocyanate (NDI), 3,3′-dimethyl-4,4′-diisocyanatodiphenyl (TODI), dianisidine diisocyanate (DADI), 1,3,5-tris-(iso-cyanatomethyl)benzene, tris-(4-isocyanatophenyl) methane and tris-(4-isocyanatophenyl)thiophosphate.

Suitable aliphatic monomeric di- or triisocyanates are especially 1,4-tetramethylene diisocyanate, 2-methylpentamethylene-1,5-diisocyanate, 1,6-hexamethylene diisocyanate (HDI), 2,2,4- and 2,4,4-trimethyl-1,6-hexa-methylene diisocyanate (TMDI), 1,10-decamethylene diisocyanate, 1,12-dodecamethylene diisocyanate, lysine and lysine ester diisocyanate, cyclohexane-1,3- and -1,4-diisocyanate, 1-methyl-2,4- and -2,6-diisocyanato-cyclohexane and arbitrary mixtures of these isomers (HTDI or H₆TDI), isocyanato-3,3,5-trimethyl-5-isocyanatomethyl cyclohexane (=isophorone diisocyanate or IPDI), perhydro-2,4′- and -4,4′-diphenylmethane diisocyanate (HMDI or H₁₂MDI), 1,4-diisocyanato-2,2,6-trimethylcyclohexane (TMCDI), 1,3- and 1,4-bis-(isocyanatomethyl)cyclohexane, m- and p-xylylene diisocyanate (m- and p-XDI), m- and p-tetramethyl-1,3- and -1,4-xylylene diisocyanate (m- and p-TMXDI), bis-(1-isocyanato-1-methylethyl) naphthalene, dimer and trimer fatty acid isocyanates such as 3,6-bis-(9-isocyanatononyl)-4,5-di-(1-heptenyl)-cyclohexene (dimeryl diisocyanate) and α,α,α′,α′,α″,α″-hexamethyl-1,3,5-mesitylene triisocyanate.

Preferred among these are MDI, TDI, HDI and IPDI.

Suitable oligomers, polymers and derivatives of the monomeric di- and triisocyanates are especially derived from MDI, TDI, HDI and IPDI. Especially suitable among these are commercially available types, especially HDI-biurets such as Desmodur® N 100 and N 3200 (from Bayer), Tolonate® HDB and HDB-LV (from Rhodia) and Duranate® 24A-100 (from Asahi Kasei); HDI isocyanurates, such as Desmodur® N 3300, N 3600 and N 3790 BA (all from Bayer), Tolonate® HDT, HDT-LV and HDT-LV2 (from Rhodia), Duranate® TPA-100 and THA-100 (from Asahi Kasei) and Coronate® HX (from Nippon Polyurethane); HDI-uretdiones such as Desmodur® N 3400 (from Bayer); HDI-iminooxadiazine diones such as Desmodur® XP 2410 (from Bayer); HDI-allophanates such as Desmodur® VP LS 2102 (from Bayer); IPDI-isocyanurates, for example in solution as Desmodur® Z 4470 (from Bayer) or in solid form as Vestanat® T1890/100 (from Degussa); TDI oligomers such as Desmodur® IL (from Bayer); as well as mixed isocyanurates based on TDI/HDI, for example as Desmodur® HL (from Bayer). Also especially suitable are forms of MDI that are liquid at room temperature (so-called “modified MDI”), which represent mixtures of MDI with MDI derivatives, especially MDI carbodiimides or MDI uretoneimines or MDI urethanes, known under trade names such as Desmodur® CD, Desmodur® PF, Desmodur® PC (all from Bayer) or Isonate® M 143 (from Dow), as well as mixtures of MDI and MDI homologs (polymeric MDI or PMDI), available under trade names such as Desmodur® VL, Desmodur® VL50, Desmodur® VL R10, Desmodur® VL R20, Desmodur® VH 20 N and Desmodur® VKS 20F (all from Bayer), Isonate® M 309, Voranate® M 229 and Voranate® M 580 (all from Dow) or Lupranat® M 10 R (from BASF). The above-named oligomeric polyisocyanates in practice are usually mixtures of substances with different degrees of oligomerization and/or chemical structures. Preferably they have a mean NCO functionality of 2.1 to 4.0.

Preferably the polyisocyanate is selected from the group consisting of MDI, TDI, HDI and IPDI and oligomers, polymers and derivatives of the isocyanates mentioned, as well as mixtures thereof.

In some preferred embodiments, the polyisocyanate contains isocyanurate, iminooxadiazine dione, uretdione, biuret, allophanate, carbodiimide, uretoneimine or oxadiazinetrione groups.

The polyisocyanate is preferably a diisocyanate, meaning it contains on average or exactly two NCO groups. By using a diisocyanate, strictly linear polymers are obtained, which is advantageous for the toughener T since it imparts a higher thermally induced crack-resistance in the composition.

Suitable diisocyanates are especially commercially available aliphatic, cycloaliphatic, arylaliphatic and aromatic, preferably cycloaliphatic and aromatic, diisocyanates.

Preferred diisocyanates are hexamethylene 1,6-diisocyanate (HDI), 2,2,4- and 2,4,4-trimethylhexamethylene 1,6-diisocyanate (TMDI), cyclohexane 1,3- and 1,4-diisocyanate and any desired mixtures of these isomers, 1-isocyanato-3,3,5-trimethyl-5-isocyanatomethylcyclohexane (=isophorone diisocyanate or IPDI), perhydrodiphenylmethane 2,4′- and 4,4′-diisocyanate (HMDI), m- and p-xylylene diisocyanate (m- and p-XDI), m- and p-tetramethylxylylene 1,3- and 1,4-diisocyanate (m- and p-TMXDI), tolylene 2,4- and 2,6-diisocyanate (TDI) and any desired mixtures of these isomers, diphenylmethane 4,4′-, 2,4′- and 2,2′-diisocyanate and any desired mixtures of these isomers (MDI).

More preferably, the diisocyanate is selected from the group consisting of HDI, IPDI, MDI and TDI. These diisocyanates are particularly readily obtainable.

Particularly preferred as the polyisocyanate, in particular diisocyanate, are forms of MDI that are liquid at room temperature. These are especially so-called polymeric MDI as well as MDI with fractions of oligomers or derivatives thereof. The MDI (=4,4′-, 2,4′- or 2,2′-diphenylmethane diisocyanate and arbitrary mixtures of these isomers) contents of such liquid forms of MDI amounts, in particular, to 50 to 95 wt.-%, especially 60 to 90 wt.-%.

Particularly preferred as the polyisocyanate are polymeric MDI and MDI types that are preferably liquid at room temperature, which contain fractions of MDI-carbodiimides or adducts thereof.

Most preferred polyisocyanate for the synthesis of toughener T is 4,4′-, 2,4′- and 2,2′-diphenylmethane diisocyanate and arbitrary mixtures of these isomers (MDI), mixtures of MDI and MDI homologs (polymeric MDI or PMDI), in particular forms that are liquid at room temperatures, as well as MDI with fractions of oligomers or derivatives thereof. The MDI (=4,4′-, 2,4′- or 2,2′-diphenylmethane diisocyanate and arbitrary mixtures of these isomers) contents of such liquid forms of MDI amounts, in particular, to 50 to 95 wt.-%, especially 60 to 90 wt.-%.

Thus, in most preferred embodiments, said polyisocyanate is 4,4′-, 2,4′- or 2,2′-diphenylmethane diisocyanate and arbitrary mixtures of these isomers (MDI). Tougheners T based on MDI allow for especially high mechanical performance and especially high thermally induced crack resistance.

Preferably, toughener T is a linear polymer obtained by the reaction of a diol, a diisocyanate, and cardanol. By using diisocyanates, strictly linear polymers are obtained, which leads to especially high impact peel strength in the two-component composition. By using a diol (and not a triol or other higher functional polyols), toughener T is in any case a predominantly linear polymer. However, when very high functional polyisocyanates are used, e.g. with functionalities of 3 or higher, some degree of branching may occur, depending on the reaction conditions during synthesis of the isocyanate-functional prepolymer, which is not beneficial for the effect of toughener T.

To avoid this, it is thus preferred to use diisocyanates or polyisocyanates with average nominal NCO functionalities of <3, in particular <2.5.

Toughener T preferably has an apparent epoxy equivalent weight of >500 g/eq, in particular >1000 g/eq, preferably >1500 g/eq, in particular >2000 g/eq.

Component K1 of the two-component epoxy resin composition most preferably preferably contains said toughener T with an amount of between 5 and 15 wt.-%, preferably between 7.5 and 12.5 wt.-%, based on the total weight of component K1 of the two-component composition.

Other optional, but preferred ingredients comprised in component K1 are discussed further below.

The two-component epoxy resin composition contains a second component K2 comprising at least one anhydride-functional hardener B for epoxy resins and preferably a curing accelerator for anhydride-cured epoxy resins.

Component K2 preferably comprises between 10 and 100 wt.-%, more preferably between 20 and 99.5 wt.-%, in particular between 22.5 and 75 wt.-%, most preferably between 25 and 50 wt.-%, based on the total weight of component K2, of said anhydride-functional hardener B.

Hardener B may be any anhydride-functional hardener suitable for epoxy resins.

The anhydride-functional hardener B may comprise or consist of, for example, aromatic acid anhydrides, or specifically, phthalic anhydrides, pyromellitic anhydrides, trimellitic anhydrides, and the like. In some embodiments, the anhydride-functional hardener B may comprise or consist of a cycloaliphatic acid anhydride, or specifically tetrahydrophthalic anhydride, methyltetrahydrophthalic anhydride, hexahydrophthalic anhydride, methylhexahydrophthalic anhydride, methyl nadic anhydride, and the like, and, an aliphatic acid anhydride, or specifically succinic anhydride, poly(adipic anhydride), poly(sebacic anhydride), poly(azelaic anhydride), and the like.

Other suitable anhydrides include bicyclo[2.2.1]hept-5-ene-2,3-dicarboxylic anhydride, methylbicyclo[2.2.1]hept-5-ene-2,3-dicarboxylic anhydride, bicyclo[2.2.1]hept-5-ene-2,3-dicarboxylic anhydride, phthalic anhydride, pyromellitic dianhydride, hexahydrophthalic anhydride, hexahydro-4-methylphthalic anhydride, dodecenylsuccinic anhydride, dichloromaleic anhydride, chlorendic anhydride, tetrachlorophthalic anhydride, and the like. Mixtures comprising at least two anhydride curing agents may also be used. Illustrative examples are described in “Chemistry and Technology of the Epoxy Resins” B. Ellis (Ed.) Chapman Hall, New York, 1993 and in “Epoxy Resins Chemistry and Technology”, edited by C. A. May, Marcel Dekker, New York, 2nd edition, 1988.

Particular preference is given to dicarboxylic anhydrides and tetracarboxylic anhydrides or modifications thereof. The following anhydrides may be mentioned as examples at this point: tetrahydrophthalic anhydride (THPA), hexahydrophthalic anhydride (HHPA), methyltetrahydrophthalic anhydride (MTHPA), methylhexahydrophthalic anhydride (MHHPA), methylnadic anhydride (MNA), dodecenylsuccinic anhydride (DBA) or mixtures thereof. As modified dicarboxylic anhydrides preferably are used acid esters (reaction products of above-mentioned anhydrides or mixtures thereof with diols or polyols, for example: neopentyl glycol (NPG), polypropylene glycol (PPG, preferably having an average molecular weight Mₙ in the range of 200 to 1000 g/mol).

Anhydrides used as hardener B are preferably aliphatic and cyclo-aliphatic or aromatic polycarbonic acid anhydrides. Particular preference is given to dicarboxylic anhydrides and tetracarboxylic anhydrides. Among those, especially preferred are tetrahydrophthalic anhydride (THPA), hexahydrophthalic anhydride (HHPA), methyltetrahydrophthalic anhydride (MTHPA), methylhexahydrophthalic anhydride (MHHPA), methylnadic anhydride (MNA), dodecenylsuccinic anhydride (DBA) or mixtures thereof. Preferred are furthermore phthalic anhydride (PA), methylhydrophthalic anhydride (MHPA). MTHPA is commercially available and exists in different forms, e.g. as 4-methyl-1,2,3,6-tetrahydrophthalic anhydride or as 4-methyl-3,4,5,6-tetrahydrophthalic anhydride. Although the different forms are not critical for the application in the present invention, 4-methyl-1,2,3,6-tetrahydrophthalic anhydride and 4-methyl-3,4,5,6-tetrahydrophthalic anhydride are the preferred compounds to be used. Methyltetrahydrophthalic anhydride (MTHPA) is often supplied commercially as a mixture containing MTHPA isomers as the main component, together with other anhydrides, such as tetrahydrophthalic anhydride (THPA), methylhexahydrophthalic anhydride (MHHPA) and/or phthalic anhydride (PA). Such mixtures may also be used within the scope of the present invention. The content of MTHPA within such a mixture is preferably at least 50% by weight, preferably at least 60% by weight, preferably at least 70% by weight, preferably at least 80% by weight, and preferably at least 90% by weight, calculated to the total weight of the mixture.

In especially preferred embodiments, hardener B comprises so-called modified anhydrides. The term “modified anhydride” means reaction products of, in particular dicarboxylic, anhydrides with diols or polyols, resulting in carboxylic acid esters with remaining acid functionalities that are able to undergo cross-linking reactions with the epoxy resin A and/or other constituents of the two-component epoxy resin composition.

Accordingly, in preferred embodiments, hardener B comprises a reaction product of at least one anhydride with at least one diol or polyol.

Suitable as anhydrides for said reaction product are all anhydrides mentioned before further above, in particular dicarboxylic anhydrides and tetracarboxylic anhydrides. Among those, especially preferred are tetrahydrophthalic anhydride (THPA), hexahydrophthalic anhydride (HHPA), methyltetrahydrophthalic anhydride (MTHPA), methylhexahydrophthalic anhydride (MHHPA), methylnadic anhydride (MNA), dodecenylsuccinic anhydride (DBA) or mixtures thereof.

Suitable as polyols for said reaction product are diols and polyols having more than two hydroxyl functions, in particular glycols, preferably C₃ to C₁₂ alkane diols, and polyoxyalkylene diols, in particular polyoxyalkylene diols having an average molecular weight Mₙ in the range of 200 to 1000 g/mol, preferably polypropyle glycols.

Most preferred anhydride for said reaction product is tetrahydrophthalic anhydride (THPA) and most preferred polyol for said reaction is neopentyl glycol.

The reaction to produce all forms of said reaction product is in particular performed under nitrogen atmosphere and preferably using a molar ratio of anhydride to polyol of approximately 2:1.

In an especially preferred embodiment of the two-component epoxy resin composition according to the present invention, said reaction product is a reaction product of tetrahydrophthalic anhydride (THPA) and neoptentyl glycol (NPG), preferably reacted in a molar ratio of 2:1.

In preferred embodiments, hardener B comprises up to 50 wt.-%, preferably between 10 and 30 wt.-%, of said reaction product, based on the total of hardener B within the composition.

The use of such a reaction product together with the toughener according to the present invention leads to a synergistic effect that enhances the beneficial properties brought about by the toughener,

The amount hardener B used within the two-component composition is preferably 50 to 170 parts by mass, and more preferably 80 to 150 parts by mass relative to 100 parts by mass of the thermosetting base resin. If the amount of curing agent blended is less than 50 parts by mass, the glass transition temperature (Tg) may decrease due to the shortage of cross-links, and if the amount of curing agent blended is greater than 170 parts by mass, the moisture resistance, the intense-heat deformation temperature, and the heat resistance stability may deteriorate.

In most preferred embodiments of the two-component epoxy resin composition according to the present invention, said hardener B comprises or consists of cycloaliphatic anhydrides, in particular methyl tetrahydrophthalic anhydride (MTHPA) isomers.

Furthermore, the hardener component K2 may preferably comprise an accelerator.

An accelerator, synonymously called curing accelerator, may be added to the resin composition as an optional component.

Suitable accelerators are substances which accelerate the reaction between amino groups and epoxide groups, in particular acids or compounds hydrolyzable to acids, in particular organic carboxylic acids such as acetic acid, benzoic acid, salicylic acid, 2-nitrobenzoic acid, lactic acid, organic sulfonic acids such as methanesulfonic acid, p-toluenesulfonic acid or 4-dodecylbenzenesulfonic acid, sulfonic acid esters, other organic or inorganic acids such as in particular phosphoric acid, or mixtures of the abovementioned acids and acid esters; Tertiary amines such as in particular the already mentioned accelerator B, or 1,4-diazabicyclo[2.2.2]octane, triethanolamine, imidazoles such as in particular N-methylimidazole, N-vinylimidazole or 1,2-dimethylimidazole, salts of such tertiary amines, quaternary ammonium salts, in particular benzyltrimethylammonium chloride, amidines, in particular 1,8-diazabicyclo[5.4.0]undec-7-enes, guanidines, in particular 1,1,3,3-tetramethylguanidine, phenols, in particular bisphenols, phenol-resins or Mannich bases such as in particular 2,4,6-tris(dimethylaminomethyl) phenol or 2,4,6-tris(N, N-dimethyl-4-amino-2-azabutyl) phenol, phosphites such as in particular di- or triphenyl phosphites, or mercapto-containing compounds. Preferred as accelerators are acids, tertiary amines or Mannich bases.

Most preferred among those is salicylic acid or 2,4,6-tris(dimethylaminomethyl) phenol or 2,4,6-tris(N,N-dimethyl-4-amino-2-azabutyl) phenol or a combination thereof.

Furthermore preferred as accelerators are in particular compounds comprising at least one dimethylamino group. in particular benzyldimethylamine, α-methylbenzyldimethylamine, N, N-diethyl-N′,N′-dimethyl-1,3-propanediamine, N, N-dimethylethanolamine, 3-(N,N-dimethylamino) propane-1-ol, 2- or 4-(dimethylaminomethyl) phenol, 2,4- or 2,6-bis(N,N-dimethylaminomethyl) phenol, 2,4,6-tris(N,N-dimethylaminomethyl) phenol, 2,4,6-tris(N,N-dimethyl-4-amino-2-azabutyl) phenol or in particular N,N,N′,N′-tetra-methyl-1,2-ethanediamine, N,N,N′,N′-tetramethyl-1,3-propanediamine, N,N,N′,N′-tetramethyl-1,4-butanediamine, N, N,N′,N′-tetramethyl-1,6-hexanediamine, N, N,N′,N′, N″-pentamethyldiethylenetriamine, N, N,N′,N′, N″-Pentamethyldipropylentriamine, N, N,N′,N′, N″-pentamethyl-N-(2-aminoethyl)-1,3-propanediamine, N, N-dimethyl-1,2-ethanediamine, N, N-dimethyl-1,3-propanediamine, N,N-dimethyl-1,4-butanediamine, N, N-dimethyl-1,6-hexanediamine, 2-(2-(dimethylamino)ethylamino)ethylamine, 2-(3-(dimethylamino) propylaminoethylamine, 3-(2-(dimethylamino)ethylamino) propylamine, 3-(3-(dimethylaminopropylamino) propylamine (DMAPAPA), Bis (2-(N,N-dimethylamino)ethyl) amine or bis(3-(N,N-dimethylamino) propyl) amine.

Suitable as accelerator are in particular imidazole or derivatives thereof, tertiary amines, boric acid esters, Lewis acids, organometallic compounds, organic acid metal salts, and the like, which also may be employed as arbitrary mixtures of these compounds.

Most preferred curing accelerators to be used in component K2 are imidazole or compound having imidazole functionalities and Lewis acid accelerators designed for room temperature latent, high temperature curing epoxy resin compositions, such as boron trichloride amine complexes. An especially suitable such example is OMICURE® BC-120 (Huntsman).

Preferably, component K2 comprises between 0.1 and 1 wt.-%, in particular between 0.2 and 0.8 wt.-%, preferably between 0.25 and 0.6 wt.-%, based on component K2, of said at least one curing accelerator for anhydride-cured epoxy resins. Higher amounts of curing accelerator generally lead to faster curing under curing conditions.

Other optional, but preferred ingredients comprised in component K2 are discussed below.

The two-component composition preferably comprises in either one or both of components K1 and K2 of the two-component epoxy resin composition contain at least one filler with an amount of between 20 and 75 wt.-%, preferably between 30 and 65 wt.-%, based on the total weight of the respective component K1 and K2.

Preferably, bot components K1 and K2 contain fillers in these amounts.

The use of fillers is advantageous in that they improve the aging resistance of the adhesive and advantageously influence the mechanical properties and/or application properties.

Suitable as filler are inorganic and organic fillers, for example, ground or precipitated calcium carbonates, optionally coated with fatty acids, in particular stearates, barium sulfate (heavy spar), talcs, quartz flours, quartz sands, dolomites, wollastonites, kaolins, mica (potassium aluminum silicate), molecular sieves, aluminas, aluminum hydroxides, silicas (pyrogenic or precipitated), cristobalite, cements, gypsums, flue ashes, carbon blacks, graphite, metal powders such as aluminum, copper, iron, silver, or steel, PVC powders or hollow spheres, such as solid or hollow glass spheres and organic hollow spheres.

Furthermore suitable as filler are layer minerals, in particular layered minerals exchanged with organic ions. The ion-exchanged layered mineral may be either a cation-exchanged or an anion-exchanged layered mineral. It is also possible that the adhesive simultaneously contains a cation-exchanged layered mineral and an anion-exchanged layered mineral. Such layered minerals may have the additional advantage of acting as corrosion inhibitors. Preferred as a layer mineral is a layered silicate.

Moreover, the two-component epoxy resin composition may comprise further additives in either one or both of components K1 and K2. These are, for example:
solvents, film forming auxiliaries or extenders such as toluene, xylene, methylethyl ketone, 2-ethoxyethanol, 2-ethoxyethyl acetate, benzyl alcohol, ethylene glycol, diethylene glycol butyl ether, dipropylene glycol butyl ether, ethylene glycol butyl ether, ethylene glycol phenyl ether, N-methylpyrrolidone, propylene glycol butyl ether, propylene glycol phenyl ether, diphenylmethane, diisopropylnaphthalene, mineral oil fractions such as, for example, Solvesso types (from Exxon), aromatic hydrocarbon resins, in particular phenol group containing types, sebacates, phthalates, organic phosphoric and sulfonic esters and sulfonamides;
reactive dilutants, e.g., epoxy reactive dilutants which have been mentioned above, epoxidized soy oil or flax oil, compounds having acetoacetate groups, in particular acetoacetylated polyols, butyrolactone as well as, moreover, isocyanates and silicones having reactive groups;
polymers such as, e.g., polyamides, polysulfides, polyvinylformal (PVF), polyvinylbutyral (PVB), polyurethanes (PUR), polymers containing carboxylic groups, polyamides, butadiene-acrylonitrile copolymers, styrene-acrylonitrile copolymers, butadiene-styrene-copolymers, homo- or copolymers of unsaturated monomers, in particular of the group comprising ethylene, propylene, butylene, isobutylene, isoprene, vinyl acetate, and alkyl(meth)acrylates, in particular chlorosulfonated polyethylenes and polymers containing fluorine, sulfonamide-modified melamines, and cleaned montan waxes;
fibers, for example, of plastics, carbon, or glass;
pigments, for example, titanium dioxide or iron oxides or organic pigments;
rheology modifiers such as, in particular, thickeners, for example, sheet silicates such as bentonites, derivatives of castor oil, hydrogenated castor oil, polyamides, polyurethanes, urea compos, hydrophilic pyrogenic silicas, cellulose ethers, and hydrophobically modified polyoxyethylenes;
adhesion promoters, for example, organoalkoxysilanes such as 3-glycidoxypropyltrimethoxysilane, 3-aminopropyltrimethoxysilane, N-(2-aminoethyl)-3-aminopropyltrimethoxysilane, N-(2-aminoethyl)-N′[3-(trimethoxysilyl) propyl]ethylenediamine, 3-ureidopropyltrimethoxysilane, 3-chloropropyltrimethoxysilane, vinyltrimethoxysilane, or the corresponding organosilanes with ethoxy groups or (poly) etheroxy groups instead of methoxy groups;
oxidation, corrosion, heat, light, and UV radiation stabilizers;
flame retardant filers or additives, in particular compounds such as alumina (Al(OH)₃; also called ATH for “aluminum trihydrate”), magnesium hydroxide (Mg(OH)₂; also called MDH for “magnesium dihydrate”), ammonium sulfate ((NH₄)₂SO₄), boric acid (B(OH)₃), zinc borate, melamine borate, and melamine cyanurate; compounds containing phosphorus such as ammonium phosphate ((NH₄)₃PO₄), ammonium polyphosphate, melamine phosphate, melamine pyrophosphate, triphenyl phosphate, diphenyl cresyl phosphate, tricresyl phosphate, triethyl phosphate, tris-(2-ethylhexyl) phosphate, trioctyl phosphate, mono-, bis-, and tris(isopropylphenyl) phosphate, resorcinolbis(diphenyl phosphate), resorcinol diphosphate oligomer, tetraphenylresorcinol diphosphite, ethylendiamine diphosphate, and bisphenol A bis(diphenyl phosphate); halogen-containing compounds such as chloroalkylphosphates, in particular tris(chloroethyl) phosphate, tris(chloropropyl) phosphate, and tris(dichloroisopropyl) phosphate, polybrominated diphenyl ethers, in particular decabromodiphenyl ether, polybrominated diphenyl oxide, tris[3-bromo-2,2-bis(bromomethyl)propyl] phosphate, tetrabromo bisphenol A, bis(2,3-dibromopropyl ether) of bisphenol A, brominated epoxy resins, ethylene-bis(tetrabromophtalimide), ethylenebis(dibromonorbornanedicarboximide), 1,2-bis-(tribromophenoxy) ethane, tris(2,3-dibromopropyl) isocyanurate, tribromophenol, hexabromocyclododecane, bis(hexachlorocyclopentadieno)cyclooctane, and chloroparaffins; as well as combinations of a halogen-containing compo and antimony trioxide (Sb203), or antimony pentoxide (Sb205);
surfactants such as, for example, wetting agents, flow control agents, deaerating agents or defoaming agents;
biocides, such as, for example, algicides, fungicides or substances that inhibit fungal growth.

It is clear and known to a person skilled in the art which additives may be added to the resin component K1 and which may be added to the hardener component K2. Here, in particular, it has to be ensured that the storage stability is not or only slightly impaired by such additives. Thus, it is clear to a person skilled in the art that for example an amine-functional compound may react with epoxides in the resin component K1 and can consequently only be comprised in the hardener component K2 or should be omitted at all.

In preferred embodiments, the two-component epoxy resin composition contains in either one or both of components K1 and K2 additives, preferably selected from the list consisting of adhesion promoters, wetting agents, and degassing agents, with an amount of between 0.1 and 5 wt.-%, preferably between 0.25 and 4 wt.-%, in particular between 0.5 and 3 wt.-%, based on total two-component composition.

A preferred embodiment of the two-component epoxy resin composition according to the present invention consists of:
said first component K1, comprising between 25 and 50 wt.-%, based on component K1, of said least one epoxy resin A, and between 0.1 and 1 wt.-%, based on component K1, of at least one thixotropy additive, and between 25 and 65 wt.-%, based on component K1, of at least one filler, and between 5 and 15 wt.-%, based on component K1, of said toughener T;
said second component K2, comprising between 25 and 50 wt.-%, based on component K2, of said hardener B for epoxy resins, and between 25 and 70 wt.-%, based on component K2, of at least one filler, and between 0.1 and 1 wt.-%, based on component K2, of at least one thixotropy additive, and between 0.1 and 1 wt.-%, based on component K2, of at least one curing accelerator for anhydride-cured epoxy resins.

In the two-component epoxy resin composition according to the present invention, the ratio of the number of amine groups which are reactive toward epoxide groups relative to the number of anhydride groups is preferably in the range of 0.7 to 1.5, in particular 0.8 to 1.2.

Preferably, the mixing ratio by volume or weight of the two components K1 and K2 is adjusted such that the mentioned ratio of the number of anhydride groups which are reactive toward epoxide groups relative to the number of epoxide groups is established.

Alternatively, the respective amounts of epoxy resin A and hardener B within component K1 and K2, respectively, is adjusted such that the above mentioned ratio of the number of anhydride groups which are reactive toward epoxide groups relative to the number of epoxide groups is established in a given mixing ratio, for example as defined by the application apparatus. A preferred mixing ratio is mixing ratio by weight of component K1: component K2 is between 10:1 and 1:1.

Another preferred mixing ratio is approximately 1:1 by volume. This mixing ratio has the advantage that a more precise, more homogeneous mixing can be achieved and furthermore, the mixing and measuring process is simplified, for example by employing a double cartridge gun with attached static mixer and two pistons moving simultaneously.

The components K1 and K2 of the two-component epoxy resin composition are stored before mixing and application in separate containers. A suitable container for storing the resin K1 or hardener K2 component is in particular a barrel, a bag, a bucket, a can, a cartridge or a tube. The components are storage-stable, which means that they can be stored for several months to a year or longer before use, without changing in their respective properties to a degree relevant to their use. For the application of the epoxy resin composition, the resin and the hardener component K1 and K2 and an optionally present further component are mixed together shortly before or during the application.

The mixing of the components takes place by means of a suitable method. The mixing can be continuous or batch wise. If the mixing takes place before the application, care must be taken that the mixing of the components and the application does not take too much time, since this can lead to disturbances, for example to a slowed or incomplete buildup of the adhesion. The mixing takes place in particular at ambient or preferably elevated temperature, which is typically in the range of about 20° C. to 80° C., preferably at about 25° C. to 60° C.

When mixing the components, and in particular when the temperature afterwards is raised to above 100° C., curing begins by chemical reaction. In this case, the epoxide groups of the epoxy resin A react with the anhydride groups of hardener B, in preferred embodiments supported catalytically by the accelerator. Further epoxide groups may react with one another under anionic polymerization. As a result of these reactions, the adhesive cures to a crosslinked material.

Curing takes place at elevated temperature, for example between 6° and 250° C., in particular between 10° and 200° C., preferably between 10° and 180° C. Curing at higher temperatures generally takes place faster. Important influencing factors for the curing rate are the temperature, the stoichiometry and the presence of accelerators.

As a result of the curing reaction, a cured resin is obtained.

Preferably, the curing of the adhesive takes place at a temperature of above 100° C., preferably above 110° C.

The two-component epoxy resin composition is suitable as adhesive on many substrate materials.

For example, suitable materials include:
metals or alloys such as aluminum, iron, steel or non-ferrous metals, or surface-refined metals or alloys such as galvanized or chromium-plated metals;
Wood, wood-resin composites, such as phenolic, melamine or epoxy resins, bonded wood materials or other so-called polymer composites;
Stone, ceramics, glass, tiles;
Plastics, in particular hard or soft polyvinyl chloride (PVC), flexibilized poly-olefin (Combiflex®), adhesion-modified chlorosulfonated polyethylene (Hypalon®), ABS, polycarbonate (PC), polyamide (PA), polyester, PMMA, epoxy resins, PUR, POM, PO, PE, PP, EPM or EPDM, the plastics optionally being replaced by plasma, corona or flames are surface treated; and
Fiber reinforced plastics such as Carbon Fiber Reinforced Composite Plastics (CFRP), Glass Fiber Reinforced Plastics (GRP) or Sheet Molding Compounds (SMC).

A further aspect of the present invention is the use of a two-component epoxy resin composition as described before as electrical insulation for electric or electronic equipment or as casting resin in industrial assembly. All preferred embodiments as described for the general two-component composition detailed above equally apply to this use aspect.

A further aspect of the present invention is the use of a toughener T as defined throughout this document as additive for improving thermal shock induced crack stability in a two-component, anhydride-cured epoxy resin composition. All preferred embodiments of toughener T are in this aspect the same as for the toughener T in general, as described further above. Preferred embodiments of that two-component epoxy resin composition are the same as those defined throughout this document.

Yet another aspect of the present invention is an electrically insulated article, wherein the resin for the insulation is a two-component epoxy resin composition as described further above.

### EXAMPLES

Examples are given below which illustrate the invention further but do not limit the scope of the invention in any way and merely illustrate some of the possible embodiments. “Standard conditions” or “norm climate” (“NK”) refers to a temperature of 23° C. and 50% relative humidity (r.h.).

### Test Methods

The following test methods were employed:

### Glass Transition Temperature (Tg)

Glass transition temperature (Tg) of the cured two-component compositions was done using a Mettler Toledo DSC 3 differential scanning calorimetry setup. The analyzed temperature range was in all cases 25° C.-250° C., using the DSC equipment's “method 5” configuration with a temperature gradient of 20° C./min.

### Thermally Induced Crack Formation Test

In order to assess the thermally induced crack resistance, each mixed two-component composition (as detailed in Tables 2 and 3) immediately after mixing was poured into an aluminum cup (inner diameter 60 mm, height 20 mm). After that, an aluminum spiral-shaped element with one rotation (external diameter 37 mm, internal diameter 25 mm, thickness 6 mm, stagger 6 mm) having a square section was introduced into the mixed composition in the cup and fully submerged in the composition. Then, the sample was cured (details see below and Table 4 for each experiment) according to the specifications below. After curing, the test sample consisted of a glassy, cured resin with the spiral-shaped element fully contained within the resin. In order to assess the thermally induced crack resistance, the respective samples were exposed to harsh thermal gradient cycles that lead to contraction and expansion of the spring-shaped metal element and are suitable to determine the material's ability to withstand the resulting forces without cracking. The temperature gradients used consisted of cycles of cooling the samples down to −18° C., followed by heating to 85° C. After such 6 cycles the experiments were stopped, if no cracks appeared before. Table 4 summarizes the observations.

### Example Two-Component Epoxy Resin Compositions

A series of two-component example composition were prepared using the substances listed in Table 1 and the synthesized additional tougheners described further below. Tables 2, 3 and 5 show example compositions consisting of components K1 and K2. All amounts in these tables are in wt.-% (percent by weight) based on the respective component K2 or K2.

The individual components K1 in each experiment were prepared as follows: First, the epoxy resins were weighted into a pail and pre-heated at 70° C. in an oven for 3 hours and afterwards placed onto a heating plate with a temperature regulation (55-60° C.) and a mechanical stirrer. Then, the pre-heated (40° C., 3 h) toughener was added (where applicable) and the mixture mixed for 20 minutes while regulating the temperature at 55-60° C. All further ingredients were added stepwise and the mixture was mixed for 10 minutes under temperature regulation (55-60° C.). Then, the filler was added gradually under rapid agitation by the mixer and temperature regulation (55-60° C.). After the end of the filler addition, mixing was continued for 10 minutes. The thus completed component K1 was placed in a vacuum chamber equipped with a stirrer for air degassing.

The individual components K2 in each experiment were prepared as follows: First, “Mod. Anhydride” hardener (where applicable) was weighted into a pail and pre-heated at 70° C. in an oven for 4 hours and afterwards placed onto a heating plate with a temperature regulation (55-60° C.) and a mechanical stirrer. Accelerator (where applicable) was added and stirred for 5 minutes at the same temperature. Then, the pre-heated (40° C., 4 h) MTHPA was added (where applicable) and the mixture mixed for 5 minutes while regulating the temperature at 55-60° C. All further ingredients were added stepwise and the mixture was mixed for 10 minutes under temperature regulation (55-60° C.). Then, the filler was added gradually under rapid agitation by the mixer and temperature regulation (55-60° C.). After the end of the filler addition, mixing was continued for 10 minutes. The thus completed component K2 was placed in a vacuum chamber equipped with a stirrer for air degassing.

The two components K1 and K2 in each respective experiment were mixed together using the respective weight ratio as shown in Tables 4 and 6 under reduced pressure and using a mechanical stirrer.

After this, the mixed material was used for the thermally induced crack formation test (details above) or for the glass transition temperature (Tg) measurements. Curing was done in an oven using the respective curing time and curing temperature as detailed in Tables 4 and 6.

TABLE 1
Employed chemicals and ingredients.

| | | Trade name |
|---|---|---|
| Abbreviation | Description | (supplier) |
| BADGE | Bisphenol A diglycidyl ether (main epoxy | Epikote ® 828 |
| | resin), EEW = 189 g/eq. | (Hexion) |
| Silane A-187 | Gamma-glycidoxypropyltrimethoxysilane | Silquest* A-187 |
| | (adhesion promoter) | (Momentive) |
| CSR | 33% Core shell rubber in unmodified epoxy | Kane Ace ® MX |
| | resin based on bisphenol-A (toughener) | 153 (Kaneka) |
| Defoamer | Polysiloxane | Byk ® A 525 (Byk |
| | | Chemie) |
| Rheology | Solution of polyhydrocarboxylic acid amides | Rheobyk ®-R-605 |
| additive 1 | | (Byk Chemie) |
| Wetting agent | Solution of a copolymer with acidic groups | Byk ® W 995 (Byk |
| | | Chemie |
| ATH | Aluminium hydroxide (filler) | — |
| Silica-EP | Silica with epoxy silane surface treatment | Silbond ® 126 |
| | (filler) | EST |
| | | (Quarzwerke) |
| Silica | Pyrogenic, hydrophobic silica (filler) | — |
| Mod. Anhydride | Modified liquid carboxylic acid anhydride, | — |
| | consisting of a reaction product of | |
| | tetrahydrophthalic anhydride (THPA) and | |
| | neopentyl glycol (NPG) (weight ratio 2:1) and | |
| | diluted with MTHPA (30 wt.-% reaction product | |
| | in MTHPA) | |
| MTHPA | Blend of cycloaliphatic anhydride, mainly | MTHPA NG ® |
| | methyl tetrahydrophthalic anhydride isomers | (Polynt) |
| Accelerator 1 | 1-Methylimidazole (curing accelerator) | Biresin ® CA144 |
| | | (Sika) |
| Accelerator 2 | Boron trichloride dimethyl octyl amine complex | Omicure ® BC |
| | (curing accelerator) | 120 (CVC) |
| Drying agent | Synthetic zeolite type A3 (3 Å) | Siliporite ® 1720 |
| | | (Arkema) |
| Rheology | Hydrophobic fumed silica | CAB O SIL ® TS |
| additive 2 | | 720 (Cabot) |

For testing, a homogenous mixture of each respective component K1 and K2 in each example two-component composition was prepared using a stirrer and directly applied to the substrate surfaces used for preparing the test pieces. Immediately after mixing of the components K1 and K2, the testing protocol was employed. Test data is shown for each composition in Tables 2 to 6 at the end of the table.

### Synthesis of Exemplary Toughener T1 (According to Invention)

Under nitrogen atmosphere, 5687 g of Acclaim® 4200 polyol (Bayer MaterialScience) 712 g (2 equivalents) of MDI with the trade name Desmodur 44 MC L (Covestro) and 0.6 g catalyst DABCO 33 LV (Air Products) were heated with constant stirring to 80° C. and left at this temperature to produce an NCO-terminated prepolymer. After one hour of reaction time, a free NCO content was determined by titration. It had reached a content of isocyanate groups of 1.9 wt.-%. Subsequently, 910 g cardanol with the trade name Cardolite NC-700 (Cardolite) were added and stirring was continued for a further 2 hours at 80° C. The reaction was stopped as soon as free isocyanate was no longer detectable by IR spectroscopy (wavenumbers 2275-2230 cm⁻¹).

### Synthesis of Exemplary Toughener T2 (Reference)

150 g of isocyanate-terminated prepolymer, produced from 60% by weight PolyTHF® 2000 (BASF), 40% by weight Poly BD® R45V (Cray Calley), Isophorone diisocyanate (Evonik) (0.75 equivalents) and dibutyl tin dilaurate catalyst, was treated with 1 equivalent of dry Epikote® 828LVEL (Hexion). Next, 8.11 mmol phthalic anhydride (Sigma Aldrich) were added, the reaction mixture was mixed and then reacted at 110° C. under vacuum by adding catalyst.

TABLE 2
Details of compositions C1 to C4. All numbers in wt.-%.

| | C1 (Ref.) | C2 (Ref.) | C3 (Ref.) | C4 (Ref.) |
|---|---|---|---|---|
| Component K1 | | | | |
| BADGE | 14.7 | 14.7 | 26.7 | 43.5 |
| Toughener T2 | 12.0 | — | — | — |
| CSR | — | 20 | — | — |
| Silane A-187 | 2.3 | 2.3 | 2.3 | — |
| Defoamer | 0.1 | 0.1 | 0.1 | — |
| Rheology additive 1 | 0.1 | 0.1 | 0.1 | — |
| Wetting agent | 0.1 | 0.1 | 0.1 | — |
| ATH | 70.7 | 62.7 | 70.7 | — |
| Silica-EP | — | — | — | 56.5 |
| TOTAL | 100 | 100 | 100 | 100 |
| Component K2 | | | | |
| Mod. Anhydride | — | — | — | 10 |
| MTHPA | 38.6 | 38.6 | 38.6 | 26.3 |
| Accelerator 1 | 0.2 | 0.2 | 0.2 | — |
| Accelerator 2 | — | — | — | 0.2 |
| ATH | 60 | 60 | 60 | — |
| Silica-EP | — | — | — | 63.5 |
| Drying agent | 0.8 | 0.8 | 0.8 | — |
| Rheology additive 2 | 0.4 | 0.4 | 0.4 | — |
| TOTAL | 100 | 100 | 100 | 100 |

TABLE 3
Details of compositions C5 to C8. All numbers in wt.-%.

| | C5 (Ref.) | C6 | C7 | C8 |
|---|---|---|---|---|
| Component K1 | | | | |
| BADGE | 43.5 | 38.5 | 38.5 | 38.5 |
| Toughener T1 | — | 10 | 10 | 10 |
| Defoamer | — | — | 0.2 | 0.2 |
| Rheology additive 1 | — | — | 0.2 | 0.2 |
| Wetting agent | — | — | 0.2 | 0.2 |
| Silica | 56.5 | — | — | — |
| Silica-EP | — | 51.5 | 50.9 | 50.9 |
| TOTAL | 100 | 100 | 100 | 100 |
| Component K2 | | | | |
| Mod. Anhydride | 54.8 | 10 | 10 | 10 |
| MTHPA | 44.7 | 26.3 | 26.3 | 26.3 |
| Accelerator 2 | 0.5 | 0.2 | 0.2 | 0.4 |
| Silica-EP | — | 63.1 | 63.0 | 62.8 |
| Rheology additive 2 | — | 0.4 | 0.5 | 0.5 |
| TOTAL | 100 | 100 | 100 | 100 |

TABLE 4
Test and measurement results of compositions C1 to C8.

| | Mixing ratio | | | Thermally induced crack |
|---|---|---|---|---|
| Compo- | K1:K2 | | Tg | formation test: Appearance |
| sition | (w/w) | Curing conditions | [° C.] | of cracks |
| C1 (Ref.) | 100:64 | 3 h85° C. + 18 h140° C. | n/m | Cracks visible after 2 cycles |
| | | | | (−18° C./+85° C.) |
| C2 (Ref.) | 100:55 | 3 h85° C. + 18 h140° C. | 101 | Cracks visible after 2 cycles |
| | | | | (−18° C./+85° C.) |
| C3 (Ref.) | 100:70 | 3 h85° C. + 18 h140° C. | 100 | Cracks visible even before |
| | | | | thermal shock test |
| C4 (Ref.) | 100:100 | 3 h85° C. + 18 h140° C. | n/m | Cracks visible after 3 cycles |
| | | | | (−18° C./+85° C.) |
| C5 (Ref.) | 100:36 | 3 h85° C. + 18 h140° C. | n/m | Cracks visible after 1 cycle |
| | | | | (−18° C./+85° C.) |
| C6 | 100:90 | 3 h85° C. + 18 h140° C. | 106 | No cracks visible after 6 |
| | | | | cycles (−18° C./+85° C.) |
| C7 | 100:90 | 3 h85° C. + 18 h140° C. | n/m | No cracks visible after 6 |
| | | | | cycles (−18° C./+85° C.) |
| C8 | 100:90 | 3 h85° C. + 18 h140° C. | 103 | No cracks visible after 6 |
| | | | | cycles (−18° C./+85° C.) |
| C8 | 100:90 | 4 h120° C. | 109 | No cracks visible after 6 |
| | | | | cycles (−18° C./+85° C.) |

Comparative Study with Amine-Functional Hardener

In order to assess the properties of the two-component epoxy resin composition in comparison with amine hardener-based two component epoxy resin compositions, two additional example compositions were prepared, C9 and C10 (Ref.). The respective components K1 and K2 were prepared in the same manner as the other example compositions C1 to C8 described above. The details of compositions C9 and C10 are shown in Table 5.

The polyamine used in C10 was selected such that the resulting Tg was most similar to example C9 and thus the comparability was optimal. For this reason, Jeffamine® RFD 270 was used in C9 (Jeffamine® RFD 270 (from Huntsman), cycloaliphatic ether group-containing diamine obtained from the propoxylation and subsequent amination of 1,4-dimethylol-cyclohexane, average molecular weight approx. 270 g/mol, AHEW 67 g/Eq).

Both compositions C9 and C10 were adjusted such that the resulting content of toughener T1 in both mixtures after mixing of the respective components K1 and K2 was identical and equally the amount of filler (Silica-EP) was adjusted in the same manner.

TABLE 5
Details of compositions C9 and C10. All numbers in wt.-%.

| | C9 | C10 (Ref.) |
|---|---|---|
| Component K1 | | |
| BADGE | 38.6 | 38.3 |
| Toughener T1 | 10.1 | 7.3 |
| Silica-EP | 51.3 | 54.4 |
| TOTAL | 100 | 100 |
| Component K2 | | |
| Mod. Anhydride | 9.9 | — |
| MTHPA | 26.5 | — |
| Accelerator 2 | 0.3 | — |
| Silica-EP | 62.9 | 63.2 |
| Rheology additive 2 | 0.4 | 0.4 |
| Polyamine | — | 36.4 |
| TOTAL | 100 | 100 |

For both mixtures C9 and C10, a final content of 5.3 wt.-% of toughener T1 and a final content of Silica-EP of 56.8 wt.-% was obtained, since the mixing ratio of K1:K2 (w/w) was 100:90 (C9) and 100:38.3 (C10).

The obtained mixtures of C9 and C10 were tested in the same manner as C1 to C8 (see above). The results are shown in Table 6.

TABLE 6
Test and measurement results of compositions C1 to C8.

| | Mixing ratio | | | Thermally induced crack |
|---|---|---|---|---|
| Compo- | K1:K2 | | Tg | formation test: Appearance |
| sition | (w/w) | Curing conditions | [° C.] | of cracks |
| C9 | 100:90 | 3 h85° C. + 18 h140° C. | 109 | Small cracks visible in 20% |
| | | | | of the samples after 7 |
| | | | | cycles (−18° C./+85° C.) |
| C10 (Ref.) | 100:38.3 | 3 h85° C. + 18 h140° C. | 106 | Cracks visible in 80% of the |
| | | | | samples after 7 cycles |
| | | | | (−18° C./+85° C.) |

The data in Table 6 shows that the comparative two-component composition C10, based on an amine hardener instead of an anhydride hardener, has a significantly higher tendency to form cracks after 7 cycles of thermally induced crack formation test protocol.

1. A two-component epoxy resin composition, consisting of
a first component K1 comprising at least one epoxy resin A that contains on average more than one epoxy group per molecule; and
a second component K2 comprising at least one anhydride-functional hardener B for epoxy resins;
wherein component K1 contains between 2 and 35 wt.-%, based on the total weight of component K1, of at least one toughener T, wherein said toughener T is a reaction product of at least one polymeric diol, at least one polyisocyanate, and cardanol.

2. The two-component epoxy resin composition according to claim 1, wherein said polymeric diol for said toughener T is a polyether diol.

3. The two-component epoxy resin composition according to claim 1, wherein said polymeric diol for said toughener T has an average molecular weight Mₙ, measured by GPC against polystyrene standard, of between 300 and 15′000 g/mol g/mol.

4. The two-component epoxy resin composition according to claim 1, wherein said polyisocyanate for said toughener T is 4,4′-, 2,4′- or 2,2′-diphenylmethane diisocyanate or an arbitrary mixture of these isomers.

5. The two-component epoxy resin composition according to claim 1, wherein said toughener T has an apparent epoxy equivalent weight of >500 g/eq.

6. The two-component epoxy resin composition according to claim 1, wherein said at least one epoxy resin A is liquid at 25° C., and has an epoxy equivalent weight determined according to ASTM D-1652 of between 160 and 200 g/eq.

7. The two-component epoxy resin composition according to claim 1, wherein component K1 of the two-component epoxy resin composition contains said epoxy resin A with an amount of between 10 and 85 wt.-%, based on the total weight of component K1.

8. The two-component epoxy resin composition according to claim 1, wherein component K2 of the two-component epoxy resin composition contains said hardener B with an amount of between 10 and 100 wt.-%, based on the total weight of component K2.

9. The two-component epoxy resin composition according to claim 1, wherein either one or both of components K1 and K2 of the two-component epoxy resin composition contain at least one filler with an amount of between 20 and 75 wt.-%, based on the total weight of the respective component K1 and K2.

10. The two-component epoxy resin composition according to claim 1, wherein said hardener B comprises or consists of carboxylic acid anhydrides and/or cycloaliphatic anhydrides.

11. The two-component epoxy resin composition according to claim 1, wherein said hardener B comprises a reaction product of at least one anhydride with at least one diol or polyol, and of a polyol selected from C₃ to C₁₂ alkane diols, and polyoxyalkylene diols.

12. The two-component epoxy resin composition according to claim 11, wherein said reaction product of is a reaction product of tetrahydrophthalic anhydride and neoptentyl glycol.

13. The two-component epoxy resin composition according to claim 1, wherein either one or both of components K1 and K2 of the two-component epoxy resin composition contain at least one thixotropy additive with an amount of between 0.05 and 5 wt.-%, based on the total weight of the respective component K1 and K2.

14. The two-component epoxy resin composition according to claim 1, wherein the mixing ratio by weight of component K1:component K2 is between 10:1 and 1:1.

15. The two-component epoxy resin composition according to claim 1, wherein the two-component epoxy resin composition consists of:
said first component K1, comprising between 25 and 50 wt.-%, based on component K1, of said least one epoxy resin A, and between 0.1 and 1 wt.-%, based on component K1, of at least one thixotropy additive, and between 25 and 65 wt.-%, based on component K1, of at least one filler, and between 5 and 15 wt.-%, based on component K1, of said toughener T;
said second component K2, comprising between 25 and 50 wt.-%, based on component K2, of said hardener B for epoxy resins, and between 25 and 70 wt.-%, based on component K2, of at least one filler, and between 0.1 and 1 wt.-%, based on component K2, of at least one thixotropy additive, and between 0.1 and 1 wt.-%, based on component K2, of at least one curing accelerator for anhydride-cured epoxy resins.

16. An additive for improving thermal shock induced crack stability in a two-component, anhydride-cured epoxy resin composition, the additive being a reaction product of at least one polymeric diol, at least one polyisocyanate, and cardanol.

17. An electrical insulation for electric or electronic equipment, or a casting resin in industrial assembly, comprising the two-component epoxy resin composition according to claim 1.
